(19) United States
(12) Patent Application Publication
(10) Pub. No.: US 2009/0095174 A1
(43) Pub. Date: Apr. 16, 2009

(54) CONTROLLED PRESSURE SILK SCREENING DEVICE

(76) Inventors: Robert Glyn Roberts, JR., Torrance, CA (US); Jack John Meola, Huntington Beach, CA (US); Rodolfo Antonio Mancia, Covina, CA (US)

Correspondence Address: MARC E. HANKIN, ESQ., 11414 THURSTON CIRCLE, LOS ANGELES, CA, 90049, US

(21) Appl. No.: 11/871,137

(22) Filed: Oct. 11, 2007

(51) Int. Cl. B05C 17/06

(52) U.S. Cl. 101/126

(57) ABSTRACT

This invention relates to a manually operated silk screen device that allows multi-colored graphics to be produced whose color is consistent and properly aligned on articles such as garments. The consistency in color is achieved by controlling the pressure and angle of the silk screen squeegee by a pneumatic or hydraulic mechanism. Screen frames are securely mounted and aligned within the device by a pin registration system.

### FIELD OF INVENTION

This invention relates, generally, to silk screening devices; more particularly, to multi-color silk screening devices that utilize a pressure mechanism and pin-lock alignment system in order to achieve efficient and consistent production of sample materials.

### BACKGROUND

The art of silk screening or screen printing has been used by printers for many decades in order to produce multiple copies of identical images on paper, garments, and other such articles. Designers of silk screening devices have sought to improve upon the consistency and speed with which multi-colored images could be produced on the devices. Specifically, they have sought to make improvements on the inconsistencies created when different machine operators applied different pressures to the screen squeegee and the distortions caused by misalignment of screens for applying different colors to the fabrics. While these problems have been somewhat rectified in many expensive, automated, mass-production devices known in the art, there remains a need for a manually operated device that can produce consistent high-quality sample articles on a silk screen printing device.

In silk screen printing operations, a squeegee containing an ink is moved across a stencil such that the open areas of the stencil allow ink to be transferred to the open areas of the article to be printed upon, below. By using multiple stencils and different colored inks, applied onto a single article, the operation is able to produce multi-colored prints on a single article. One problem encountered in manually operated silk screening devices is different passes of the squeegee will apply differing degrees of pressure at different angles, thus, resulting in prints with inconsistent darkness and overall appearance. These inconsistencies naturally result as different operators apply different pressures, depending on their weight and muscle strength, and, even with the same operator, pressure variations depending on fatigue or other factors. Such inconsistencies in pressure are undesirable because the produced articles of varying colors do not appear uniform in quality. Also, when manually preparing samples prior to mass production on an automated machine, the user is not able to accurately reflect the pressure and appearance that will be produced in mass-produced articles because the user cannot match the pressure to that of the mass production machine nor can the pressure be quantified and documented.

In order to regulate squeegee pressure, several devices have employed pneumatic pressure systems in order to eliminate the inconsistencies that would occur when different machine operators use the same machine. For example, U.S. Pat. No. 4,995,316 to Kolblin discloses a screen printing machine that includes a pressure cylinder that allows the operator to control the pressure between the squeegee and the table. Because Kolblin's device employs a complex dual-cylinder mechanism, however, it is not well suited to inexpensive and easily operated devices used in producing sample products manually.

Another such device is disclosed by U.S. Pat. No. 4,079,671 to Dubuit, which teaches a screen-printing machine for printing onto an article by using a pneumatically actuated squeegee. Dubuit's device, however, is pneumatically actuated and thus, not well suited to manual production of sample articles in low-quantities. Another such device is taught by U.S. Pat. No. 4,696,228 to David et al., which teaches a silk screen device using a cantilevered support frame to hold a screen that includes a pneumatically actuated bladder. The pneumatic bladder in David's device, however, is used to position the bladder but does not assure that the pressure applied to the squeegee is consistent.

A silk-screen device employing a powered squeegee device is disclosed by U.S. Pat. No. 5,309,831 to Fuqua et al. The Fuqua disclosure, however, is for an elaborate and expensive mechanism that is better suited to mass-production of articles than the manual production of a limited number of samples. U.S. Pat. No. 6,817,288 to Flatt also discloses a screen printing apparatus that utilizes pneumatic devices. In Flatt's device, print screens are held in place by pneumatically actuated clamping devices. The clamping devices, however, do not assure that each article printed on the silk screen is printed with consistent squeegee pressure.

Thus, there remains a long-felt need in the art for a manually operated silk screen press that utilizes pneumatic controls to regulate the press' squeegee pressure to ensure the consistent production of articles.

Meanwhile, several inventions have sought to improve distortions in the printed image that result from misalignment of multiple colored screens used on the same silk screen device. These distortions may arise when, in performing multi-color silk screening using multiple stencils, the stencils are not properly aligned for each pass of the squeegee.

One such invention is disclosed by U.S. Pat. No. 5,648,189 to Newman. Newman's patent teaches a pin registration bar of aligning an image film of a screen printing frame. The registration bar includes a plurality of pins that project upwards and downwards to provide a means to align the film to the printing frame. In this manner, the pin registration bar ensures that the plurality of stencils placed on the machine use the same alignment relative to the frame. Another such device is disclosed by U.S. Pat. No. 5,226,366 to Schlife et al. Schlife's device teaches a pin registration system for aligning stencils on a silk screen frame via numerous members attached to the screen frame that attach the silk screen stencil. Both of these devices, however, are complex, requiring numerous parts and manufacturing steps in order to fabricate.

Thus, there remains a long-felt need in the art for a manual silk screen press that allows the pressure applied by the squeegee to be pneumatically regulated, includes an alignment device such that multi-colored images are properly aligned when produced by the machine, and meets the need of easy and expedient changing of the squeegee from color to color.

### SUMMARY OF THE INVENTION

This invention is directed towards overcoming the above shortcomings and teaching a manually operated silk screen press that utilizes actuating mechanisms to regulate the pressure and angle of the squeegee and a pin registration device that maintains the alignment of multiple stencils used for multi-colored images, thereby, removing ergonomic challenges.

The device comprises a frame that mounts the many components of the device. A horizontal platform attached to the frame holds the article in place which is to be silk-screened under the silk screen squeegee. The invention's pin registration system comprises a series of protrusions which are featured on at least two of the four corners of the top of the screen platform on which the screen frame rests. The screen frame features depressions or divots at locations on its underside, designed to mate with the protrusions on the screen platforms. Thus, the platform will lay in the same position relative to each and every screen frame each time a different screen frame is placed on the platform. In this manner, the pin registration system ensures that all passes of the squeegee are made over an accurately placed screen frame.

The device further comprises a mechanism that controls the vertical motion of the squeegee and the pressure and angle with which the squeegee is pressed onto the screen. Specifically, a cross beam is elevated above the screen platform and serves to mount the device's actuating components. The actuating components serve to mount the squeegee and regulate the pressure and angle that is applied to the screen as the squeegee passes over the screen. In one embodiment of the invention, the invention also features a gauge, which allows the user to monitor and regulate the pressure selected. The cross beam is mounted on a set of columns above the platform. The columns articulate along rails to pass the squeegee over the platform.

The actuating components are configured such that the pressure and angle exerted by the squeegee is monitored and kept consistent for each pass of the squeegee. In this way, any user that operates the device at any time, can produce consistent silk screened articles. Also, different passes of the squeegee will ink the article with a consistent amount of ink. Moreover, by matching the pressure exerted by the device to the pressure exerted by a mass production silk screening machine, or a pressure to obtain corresponding results, the device can produce sample articles that will more accurately represent the mass produced articles that are to be produced. In one embodiment of the invention, the mount that holds the squeegee is controlled by a pneumatic device.

The invention may be practiced using hydraulic or pneumatic actuating mechanisms.

The motion of the squeegee along the rails can be controlled by either the manual operation of the operator or by an automated mechanism using electromechanical, pneumatic, hydraulic, or any other such mechanisms known in the art.

In those embodiments using an automated mechanism to effectuate the motion of the squeegee along the rails, the vertical motion of the squeegee with respect to the rails can be controlled by the device such that, when the pass of the squeegee is completed, the squeegee is automatically raised. The automated mechanism used can be any of the mechanisms known in the art, including pneumatic devices, hydraulic devices, electro-pneumatic, electro-hydraulic, worm gears, belt drives, chain drives, or any of the numerous other drive mechanisms known within the art.

It should be noted that, in the interests of clarity, numerous details for the functionality of the controlled pressure silk screening device and variations on the configuration of the device are not included in this disclosure. Nevertheless, these details are well known within the art and the variations remain within the contemplation of this invention.

In summary, the invention teaches a silk screening device that allows consistent production of silk screened articles through the use of a controlled pressure squeegee and a pin lock registration system for the placement of the screen frame.

### BRIEF DESCRIPTION OF THE DRAWINGS

FIG. 1 is an illustration in perspective view of the front of an embodiment of the invention without a screen frame in place and without a squeegee in place.

FIG. 2 is an illustration in perspective view of the front-right of an embodiment of the invention with a screen frame in place, and the squeegee lowered.

FIG. 3 is an illustration in perspective view of the front-right of an embodiment of the invention without a screen frame in place, and without the squeegee in place.

FIG. 4 is an illustration from a top view of the invention.

FIG. 5 is a detailed illustration of the pin lock registration system.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “pneumatic mechanism” or “controlled pressure” refers to pneumatic, hydraulic, electromechanical, or any other such devices known in the art, including those that use compressed gas or liquids to apply regulated pressure; “silk screen device” refers to any of the single or multi-colored traveling-inker stenciling devices known in the art; and “article” refers to any garment, paper, fabric, or other such device commonly printed upon using silk screening devices.

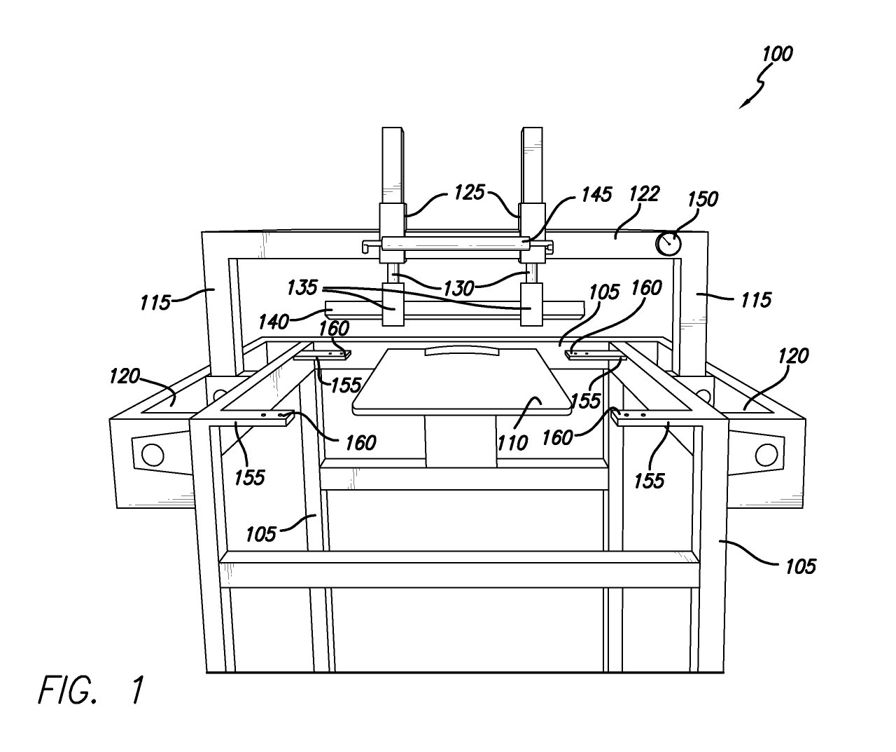

FIG. 1 is an illustration in perspective view from the front of the invention without a screen frame in place. A controlled pressure silk screening device 100 is shown along with its constituent parts including, the frame 105, which serves to support the other components of the invention, the platform 110, which serves to support an article placed within the device, and the columns 115, which serve to mount pneumatic controls of the device. The columns 115 travel along a fixed track within channels 120, which maintains the straight, consistent forward and backward motion of the columns 115. A cross beam 122 is mounted atop the columns 115 and serves to mount the pneumatic devices 125. The pneumatic devices 125 serve to contract and extend the squeegee mount 140 with respect to the cross beam 122 by extending and contracting the pneumatic columns 130. The squeegee mount 140 features two squeegee clamps 135 to which the squeegee (not illustrated in FIG. 1) is attached. An operator's handle 145 is also mounted to the cross beam 122 in order for the operator to slide the squeegee forward and backward. The device can include a gauge 150, which allows the operator to monitor the air pressure used for pneumatic control. The figure also illustrates aspects of the pin lock registration system, including the screen platforms 155 and the pins 160. The screen platforms 155 and pins 160 serve to mount the screen frame (not illustrated in FIG. 1).

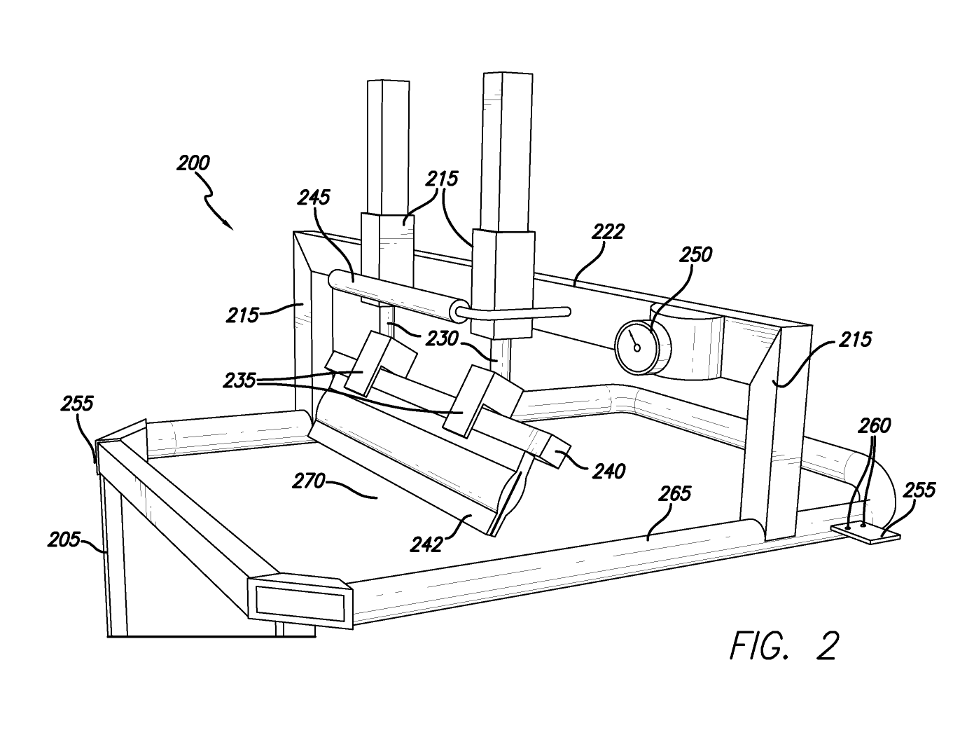

FIG. 2 is an illustration in perspective view of the front-right of an embodiment of the invention with a screen frame and squeegee 242 in place. A controlled pressure silk screening device 200 is shown along with its constituent parts including the frame 205 and the columns 215, which serve to mount pneumatic controls of the device. The columns 215 travel along a fixed track within channels to maintain the straight, consistent, forward and backward motion of the columns 215. A cross beam 222 is mounted atop the columns 215 and serves to mount the pneumatic devices 225. The pneumatic devices 225 serve to contract and extend the squeegee mount 240 by extending and contracting the pneumatic columns 230. The squeegee mount 240 features two squeegee clamps 235 to which the squeegee 242 is attached. An operator's handle 245 is also mounted to the cross beam 222 in order for the operator to slide the squeegee forward and backward. The device can include a gauge 250, which allows the operator to monitor the air pressure used for pneumatic control. The figure also illustrates the pin lock registration system configured for mounting, positioning, and securing a screen frame 265. The screen frame 265 is shown with a stencil 270 attached and mounted on the screen platforms 255 and pins 260. The pins 260 mate with depressions on the underside of the screen frame 265 in order to securely mount the screen frame 265 to the device. In this manner, the device achieves consistently aligned passes of the squeegee 242 over the article.

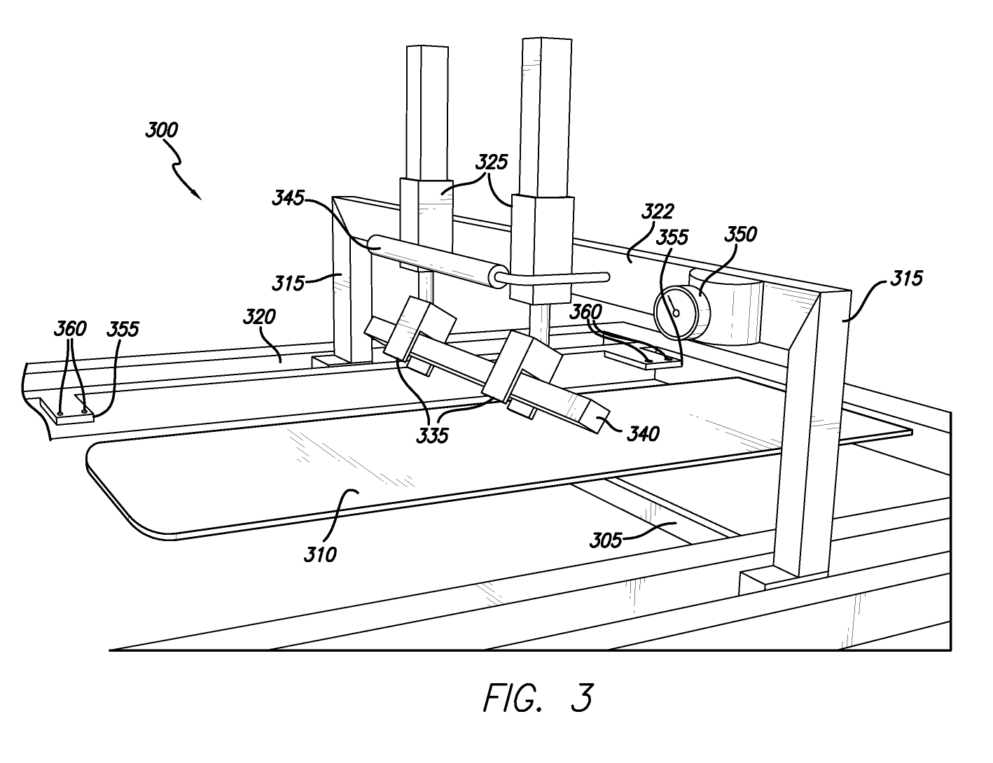

FIG. 3 is an illustration in perspective view of the front-right of an embodiment of the invention without a screen frame in place and without the squeegee in place. A controlled pressure silk screening device 300 is shown along with its constituent parts including, the frame 305 and the columns 315, which serve to mount pneumatic controls of the device. The columns 315 travel along a fixed track within channels 320 to maintain the straight, consistent forward and backward motion of the columns 315. A cross beam 322 is mounted atop the columns 315 and serves to mount the pneumatic devices 325. The pneumatic devices 325 serve to contract and extend the squeegee mount 340 by extending and contracting the pneumatic columns 330. The squeegee mount 340 features two squeegee clamps 335 configured to attach a squeegee (not illustrated in FIG. 3). An operator's handle 345 is also mounted to the cross beam 322 in order for the operator to slide the squeegee forward and backward. The device can include a gauge 350, which allows the operator to monitor the air pressure used for pneumatic control. The figure also illustrates aspects of the pin lock registration system, including the screen platforms 355 and the pins 360. The screen platforms 355 and pins 360 serve to mount and consistently align the screen frame (not illustrated in FIG. 3).

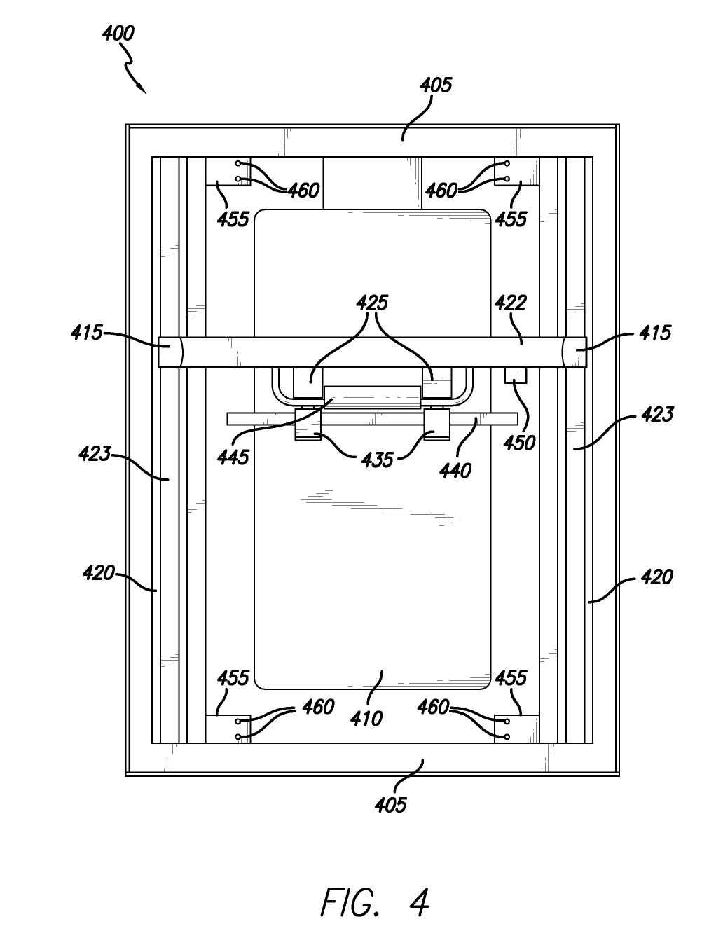

FIG. 4 is an illustration from a top view of the invention. A controlled pressure silk screening device 400 is shown along with its constituent parts including, the frame 405, which serves to support the other components of the invention, the platform 410, which serves to support the article placed within the device, and the columns 415, which serve to mount pneumatic controls of the device. The columns 415 travel along a fixed track within channels 420, to maintain the straight, consistent forward and backward motion of the columns 415. A cross beam 422 is mounted atop the columns 415 and serves to mount the pneumatic devices 425. The pneumatic devices 425 serve to contract and extend the squeegee mount 440 by extending and contracting the pneumatic columns (not visible in the viewpoint of FIG. 4). The squeegee mount 440 features two squeegee clamps 435 configured to attach a squeegee (not illustrated in FIG. 4). An operator's handle 445 is also mounted to the cross beam 422 to enable the operator to slide the squeegee forward and backward. The device can include a gauge 450, which allows the operator to monitor the air pressure used for pneumatic control. The figure also illustrates aspects of the pin lock registration system, including the screen platforms 455 at four corners of the frame 405, and the pins 460. The screen platforms 455 and pins 460 serve to mount and consistently align the screen frame (not illustrated in FIG. 4).

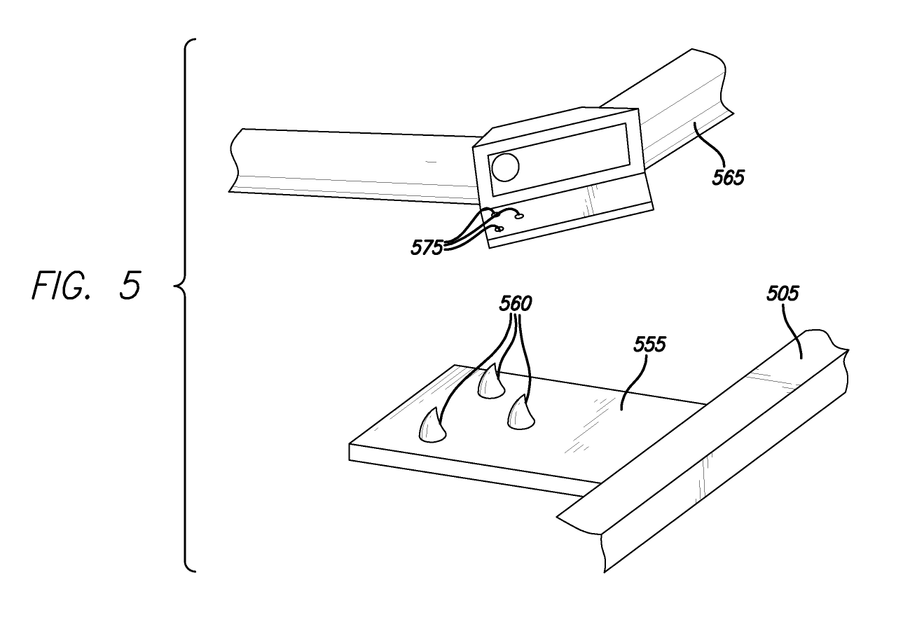

FIG. 5 is a detailed illustration of the pin lock registration system. A screen platform 555 is shown at the corner of the frame 505 of the device. Above the screen platform, a screen frame 565 is shown. When the screen frame 565 is mounted to the frame 505, the pins 560 of the screen platform 555 mate with the depressions 575 on the underside of the screen frame 565 to securely, precisely, and consistently mount and align the screen frame 565.

1. A silk screening device, comprising:
a frame, said frame being configured to mount components of the silk screening device, wherein said components include:
a platform mounted to said frame, said platform being configured to support an article placed on the silk screening device for silk screening,
a mount, said mount being configured to attach a silk screening squeegee, and
a pressure control system movably mounted to said frame, said pressure control system being configured to articulate the mount towards and away from the platform and said pressure control system being further configured to allow the operator to regulate a pressure with which the mount is pressed.

2. A silk screening device according to claim 1, wherein said mount is articulated vertically by said pressure control system.

3. A silk screening device according to claim 1, wherein said pressure control system includes a gauge whereby the pressure within the pressure control system may be monitored by the operator.

4. A silk screening device according to claim 2, wherein said pressure control system includes a gauge whereby the pressure within the pressure control system may be monitored by the operator.

5. A silk screening device according to claim 1, wherein said silk screening device further comprises one or more screen platforms mounted to said frame, said one or more screen platforms being configured to support screen frames placed on the silk screening device and including one or more pins, said pins being configured to fit matingly with depressions on the screen frames.

6. A silk screening device according to claim 2, wherein said silk screening device further comprises one or more screen platforms mounted to said frame, said one or more screen platforms being generally horizontal and configured to support screen frames placed on the silk screening device and including one or more pins, said pins being configured to fit matingly with depressions on the screen frames.

7. A silk screening device according to claim 3, wherein said silk screening device further comprises one or more screen platforms mounted to said frame, said one or more screen platforms being configured to support screen frames placed on the silk screening device and including one or more pins, said pins being configured to fit matingly with depressions on the screen frames.

8. A silk screening device according to claim 4, wherein said silk screening device further comprises one or more screen platforms mounted to said frame, said one or more screen platforms being configured to support screen frames placed on the silk screening device and including one or more pins, said pins being configured to fit matingly with depressions on the screen frame.

9. A silk screening device according to claim 1, wherein said pressure control system is selected from the group consisting of a pneumatic control system, an electro-mechanical control system, or a hydraulic control system.

10. (canceled)

11. (canceled)

12. A silk screening device according to claim 1, wherein said pressure control system is further configured to allow the operator to regulate an angle with which the mount is pressed.

13. A silk screening device, comprising:
a frame, said frame being configured to mount components of the silk screening device, wherein said components include:
a platform mounted to said frame, said platform being configured to support an article placed on the silk screening device for silk screening,
a mount, said mount being configured to attach a silk screening squeegee,
one or more columns, said one or more columns being configured to mount a beam,
one or more rails mounted to said frame, said one or more rails being configured to slidably mount said one or more columns such that said one or more columns may articulate along said one or more rails for the length of said platform,
said beam being configured to mount a pressure control system,
said pressure control system being configured to articulate the mount towards and away from the platform and said pressure control system being further configured to allow an operator to regulate a pressure and an angle at which the mount is pressed towards and away from the platform.

14. A silk screening device according to claim 13, wherein said one or more columns articulate along said one or more rails by force applied by the operator.

15. A silk screening device according to claim 13, wherein said silk screening device includes a system for articulating said one or more columns along said one or more rails, selected from the group of an electro-mechanical, a pneumatic, or a hydraulic system.

16. (canceled)

17. (canceled)

18. A silk screening device according to claim 13, wherein said mount is articulated vertically by said pressure control system.

19. A silk screening device according to claim 13, wherein said pressure control system includes a gauge whereby the pressure within the pressure control system may be monitored by the operator.

20. A silk screening device according to claim 18, wherein said pressure control system includes a gauge whereby the pressure within the pressure control system may be monitored by the operator.

21. A silk screening device according to claim 13, wherein said silk screening device further comprises one or more screen platforms mounted to said frame, said one or more screen platforms being configured to support screen frames placed on the silk screening device and including one or more pins, said pins being configured to fit matingly with depressions on the screen frames.

22. A silk screening device according to claim 18, wherein said silk screening device further comprises one or more screen platforms mounted to said frame, said one or more screen platforms being generally horizontal and configured to support screen frames placed on the silk screening device and including one or more pins, said pins being configured to fit matingly with depressions on the screen frames.

23. A silk screening device according to claim 19, wherein said silk screening device further comprises one or more screen platforms mounted to said frame, said one or more screen platforms being configured to support screen frames placed on the silk screening device and including one or more pins, said pins being configured to fit matingly with depressions on the screen frames.

24. A silk screening device according to claim 20, wherein said silk screening device further comprises one or more screen platforms mounted to said frame, said one or more screen platforms being configured to support screen frames placed on the silk screening device and including one or more pins, said pins being configured to fit matingly with depressions on the screen frame.

25. A silk screening device according to claim 13, wherein said pressure control system is a system a system for articulating said one or more columns along said or more rails, selected from the group consisting of an electro-mechanical, a pneumatic, or a hydraulic system.

26. (canceled)

27. (canceled)

28. A silk screening device, comprising:
a frame, said frame being configured to mount components of the silk screening device, wherein said components include:
a platform mounted to said frame, said platform being generally horizontal and configured to support an article placed on the silk screening device for silk screening,
a mount, said mount being configured to attach a silk screening squeegee,
one or more columns, said one or more columns being configured to mount a beam,
one or more rails mounted to said frame, said one or more rails being configured to slidably mount said one or more columns such that said one or more columns may articulate along said one or more rails for the length of said platform,
said beam being configured to mount a pressure control system,
said pressure control system being configured to articulate the mount vertically towards and away from the platform and said pressure control system being further configured to allow an operator to regulate a pressure and an angle with which the mount is pressed towards and away from said platform and including a gauge, said gauge being configured such that the pressure within the pressure control system may be monitored by the operator,
one or more screen platforms mounted to said frame, said one or more screen platforms being configured to support screen frames placed on the silk screening device and including one or more pins,
said one or more pins being configured to fit matingly with depressions on the screen frames.

29. A silk screening device according to claim 28, wherein said pressure control system is a system for articulating said one or more columns along said or more rails, selected from the group consisting of an electro-mechanical, a pneumatic, or a hydraulic system.

30. (canceled)

31. (canceled)
